(19) United States
(12) Patent Application Publication
(10) Pub. No.: US 2006/0050529 A1
(43) Pub. Date: Mar. 9, 2006

(54) Backlight module with multiple light guiding plates and a display device using the backlight module

(75) Inventors: Shen-hong Chou, Kaohsiung City (TW); Hsin-wu Lin, Taoyuan City (TW)

Correspondence Address: ARENT FOX PLLC, 1050 CONNECTICUT AVENUE, N.W., SUITE 400, WASHINGTON, DC, 20036, US

(73) Assignee: AU OPTRONICS CORPORATION

(21) Appl. No.: 10/936,598

(22) Filed: Sep. 9, 2004

(51) Int. Cl. F21V 7/04

(52) U.S. Cl. 362/600

(57) ABSTRACT

An apparatus for enhancing an LED backlight, which provides an enhanced illumination pattern across the entire display. The apparatus includes additional LED light bars positioned in between conventionally-positioned LED light bars.

### BACKGROUND OF THE INVENTION

1. Field of the Invention

The present invention relates to improvements in light-emitting diode (LED) backlights. In particular, the present invention relates to an LED backlight which produces high luminosity, thus enabling it to be used in large flat panel display devices.

2. Related Art

Liquid crystal displays (LCDs) are commonly used in televisions, computers, and cellular telephones to display information to the user. The most basic function of an LCD is to act as a light switch, allowing transmission of light in one mode and blocking transmission of light in a second mode. The LCD selectively modulates light from a backlight or a reflector (or a combination of both), with these modes being referred to as transmissive mode and reflective mode, respectively. Backlighting the LCD is a popular method of providing a light source for the LCD, since backlighting the LCD allows good functionality in low ambient light conditions and also provides enhanced contrast ratios. However, since conventional LCDs do not have high transmissivities (with most being less than 50% transmissive), relatively large amount of light must be provided for the LCD in order to produce a visible display. Furthermore, in order to prevent dark spots, the backlight must provide a substantially uniform distribution of light over the entire display. This requirement is most challenging when the display is relatively large, as in the case of some televisions or other large panel displays.

There are currently a variety of LED backlight sources being utilized and proposed. For many applications, including those relating to relatively large display panels, an important factor in the design of these systems is the luminosity, or light level, attainable by the backlighting device.

FIG. 1 illustrates a conventional LED backlight. In this example, the LED light bars are disposed along sides 11 and 12 of the display panel, i.e., along two of the four sides of the LCD panel.

FIG. 2 illustrates another conventional LED backlight. In this example, the LED light bars are disposed along sides 21, 22 and 23 of the display panel, i.e., along three of the four sides of the LCD panel.

FIG. 3 illustrates yet another conventional LED backlight. In this example, the LED light bars are disposed along sides 31, 32, 33 and 34 of the display panel, i.e., along all four sides of the LCD panel.

For many applications, the configurations illustrated in FIGS. 1, 2, and 3 accomplish their intended purpose, i.e. they provide a sufficient level of illumination, and provide it in a manner that is uniform across the display panel. However, for other applications, for example those relating to large LCD panels such as certain television sets, the light emitted from the LED must travel a large distance along the length of the LGP. In doing so, losses are experienced and the additional length of the transmission path creates a serious drawback of reducing the utility of the display, due to the presence of nonuniformities in the lighting pattern (i.e. dark spots).

In order to overcome these problems, what is needed is an LED backlight for large display panels which provides an enhanced illumination pattern across the entire display.

### SUMMARY OF THE INVENTION

It is an object of the present invention to provide an apparatus for enhancing an LED backlight which provides enhanced illumination levels across the entire display.

It is an object of the present invention to provide an apparatus for enhancing LED backlight, which provides improved uniformity to the illumination pattern across the entire display.

It is an advantage of the LED backlight disclosed herein to improve the illumination pattern for large display panels.

To achieve the foregoing objects and advantages, the present invention provides an apparatus, method and system for enhancing an LED backlight, by providing additional LED light bars positioned in between conventionally-positioned LED light bars.

### DESCRIPTION OF THE DRAWINGS

The accompanying drawings, which are included to provide a further understanding of the present invention and are incorporated in and constitute a part of this specification, illustrate examples of the present invention, together with the description of the principles of the present invention.

In the drawings:

FIG. 1 illustrates a conventional LED backlight package;

FIG. 2 illustrates a second conventional LED backlight package;

FIG. 3 illustrates a third conventional LED module;

FIG. 4 illustrates an example of an LED backlight package according to the embodiments of the present invention;

FIG. 5 illustrates another example of an LED backlight according to the embodiments of the present invention; and

FIG. 6 illustrates another example of an LED backlight according to the embodiments of the present invention.

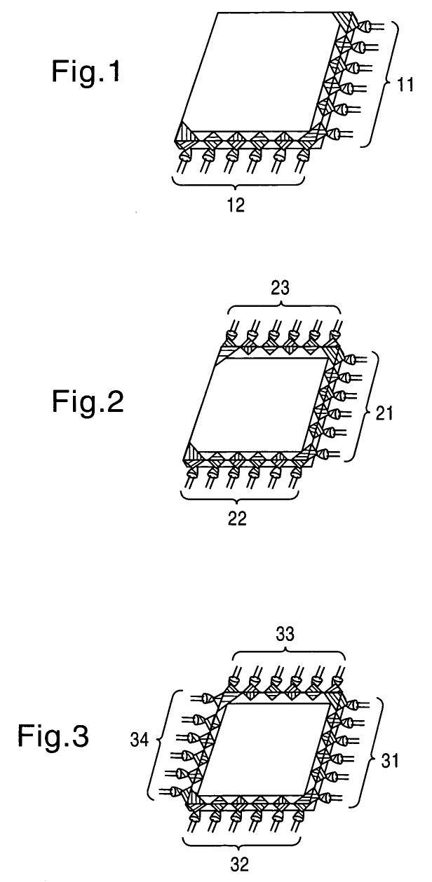

### DETAILED DESCRIPTION OF THE EXEMPLARY EMBODIMENTS

Reference will now be made in detail to the exemplary embodiments of the present invention, examples of which are illustrated in the accompanying drawings.

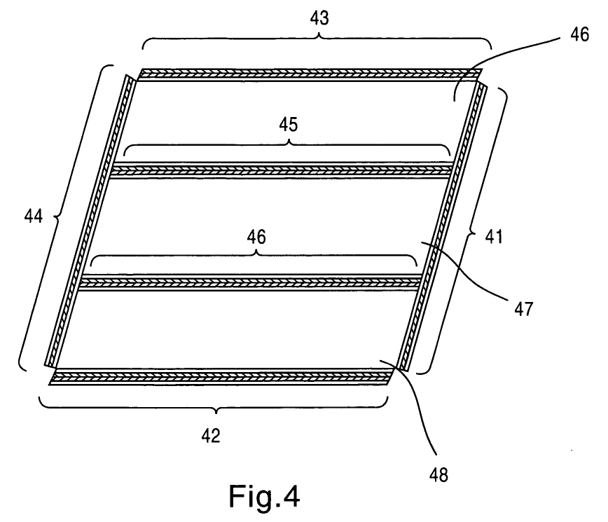

FIG. 4 illustrates an example of an LED backlight according to the principles of the present invention. In contrast to the conventional LED backlight of FIG. 3, FIG. 4 illustrates, in addition to the four light bars 41, 42, 43 and 44 disposed along the four sides of the display panel, two additional LED light bars, light bar 45 and light bar 46, disposed in the interior of the panel. This creates three LGP subpanels, each with the same horizontal dimension as the original conventional panel, but having one third of the vertical dimension. Thus, the entire panel, and in particular interior portions 46, 47 and 48, now experience higher illumination levels and therefore reduced dark spots.

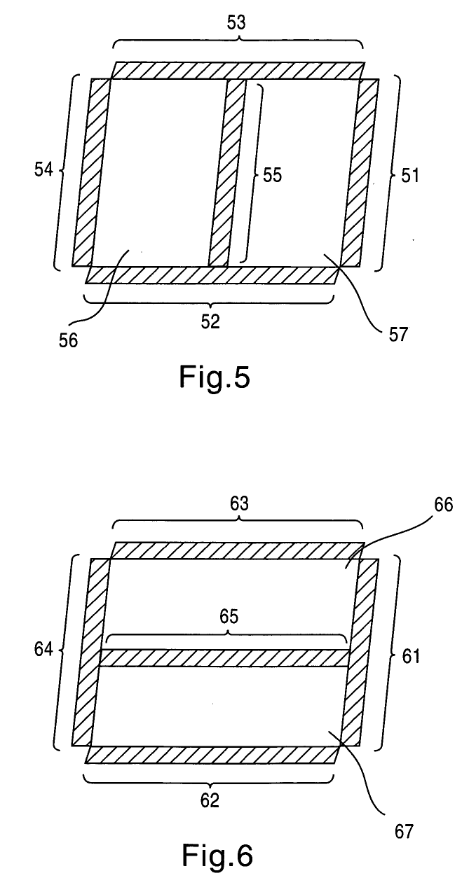

FIG. 5 illustrates another example of an LED backlight according to the principles of the present invention. The conventional example of FIG. 3 is modified in FIG. 5 by disposing a single additional light bar 55 vertically through the interior of the panel, thus creating two subpanels, each with the same vertical dimension as the original, but having half of the horizontal dimension. Again, the entire panel, and in particular interior portions 56 and 57, now experience higher illumination levels and therefore reduced dark spots.

FIG. 6 illustrates another example of an LED backlight according to the principles of the present invention. In FIG. 6 the conventional example of FIG. 3 is modified by disposing a single additional light bar 65 horizontally through the interior of the panel, thus creating two subpanels, each with the same horizontal dimension as the original, but having half of the vertical dimension. Once again, the entire panel, and in particular the interior portions 66 and 67, now experience higher illumination levels and therefore reduced dark spots.

The common principle illustrated in the examples of FIGS. 4-6 is the subdivision of a conventional panel into multiple smaller subpanels. In these cases each subpanel is bordered on four sides by LED light bars, though other examples may easily be envisioned having subpanels bordered by fewer than four sides. Other combinations of LED light bars configured in different shapes may be used of course.

It will be apparent to those skilled in the art that various modifications and variations can be made with respect to the present invention without departing from the spirit and scope thereof. Thus, it is intended that the present invention covers such modifications and variations provided that they come within the scope of the appended claims and their equivalents.

We claim:

1. A backlight module comprising:
a light guiding plate with at least one edge and an interior region;
at least one light bar having at least one light source thereon and disposed on said at least one edge of the light guiding plate; and
at least one additional light bar having at least one additional light source and disposed in said interior region of the light guiding plate.

2. The backlight module of claim 1, wherein said light source comprises a plurality of LEDs.

3. The backlight module of claim 1, wherein said additional light source comprises a plurality of LEDs.

4. The backlight module of claim 1, wherein said light guiding plate comprises a light guide plate.

5. A backlight module comprising:
a plurality light guiding plates set in array, each of the light guiding plates having at least one outer edge and at least one inner edge between the light guiding plates;
at least one light bar having at least one light source thereon and disposed on said at least one outer edge of the light guiding plate; and
at least one additional light bar having at least one additional light source and disposed on the inner edge.

6. The backlight module of claim 5, wherein said light source comprises a plurality of LEDs.

7. The backlight module of claim 5, wherein said additional light source comprises a plurality of LEDs.

8. The backlight module of claim 5, wherein said light guiding plate comprises a light guide plate.

9. A backlight module comprising:
a first light guiding plate having an inner edge and an outer edge;
a second light guiding plate disposed neighboring to the inner edge of the first light guiding plate to make a receiving space formed between the first light guiding plate and the second light guiding plate, and;
a first light source disposed within the receiving space for emitting a first light toward at least one of the first light guiding plate and the second light guiding plate.

10. The backlight module of claim 9, further comprising a second light source disposed neighboring to the outer edge for emitting a second light toward the first light guiding plate.

11. The backlight module of claim 9, further comprising a mask disposed above the receiving space to reduce the light going through the mask.

12. The backlight module of claim 9, wherein the first light source comprises a plurality of LEDs, the plurality of LEDs arranged substantially along the inner edge of the first light guiding plate.

13. The backlight module of claim 9, wherein the first light source is a cold cathode light tube that substantially extends along the inner edge of the first light guiding plate.

14. A display device comprising:
a first light guiding plate having an inner edge and an outer edge;
a second light guiding plate disposed neighboring to the inner edge of the first light guiding plate to make a receiving space formed between the first light guiding plate and the second light guiding plate;
a first light source disposed within the receiving space for emitting a first light toward at least one of the first light guiding plate and the second light guiding plate; and
a display panel disposed above the first light guiding plate, the second light guiding plate, and the receiving space.

15. The display device of claim 14, further comprising a second light source disposed neighboring to the outer edge for emitting a second light toward the first light guiding plate.

16. The display device of claim 14, further comprising a mask disposed between the display panel and the receiving space to reduce the light emitted from the first light source directly toward the display panel.

17. The display device of claim 14 wherein the first light source comprises a plurality of LEDs that are arranged substantially along the inner edge of the first light guiding plate.

18. The display device of claim 14, wherein the first light source is a cold cathode light tube that substantially extends along the inner edge of the first light guiding plate.
